(19) United States
(12) Patent Application Publication
(10) Pub. No.: US 2026/0094104 A1
(43) Pub. Date: Apr. 2, 2026

(54) RETAIL SALES KEY PERFORMANCE INDICATOR (KPI) PRESCRIPTIVE ANALYSIS

(71) Applicant: NCR Voyix Corporation, Atlanta, GA (US)

(72) Inventors: Itamar David Laserson, Givat Shmuel (IL); Shiran Abadi, Tel-Aviv (IL); Shay Marom, Kiryat Tiv'on (IL); Elisheva Chocron, Haifa (IL); Ido Botzer, Tel-Aviv (IL); Ayelet Sarel, Tel-Aviv (IL)

(21) Appl. No.: 18/902,712

(22) Filed: Sep. 30, 2024

(51) Int. Cl. G06Q 10/0639

(52) U.S. Cl. CPC G06Q 10/06393

(57) ABSTRACT

A retail prescriptive recommendations machine learning model applies a generic multi-layer architecture to specific sales key performance indicators (KPIs). The model uses a novel hierarchical logical layer of metrics and features related to sales KPIs, training on historical sales data to identify improvement opportunities, set achievable targets, and generate recommendations for each store. The implementation includes adjustments for different scales and distributions of features, a layered predictive model for hierarchical calculations, and optimization methods considering improvement directions for each feature. This solution enables store operations to make data-driven decisions to improve sales performance without requiring extensive technical or business intelligence (BI) expertise, addressing a significant challenge in retail operations management.

### BACKGROUND

Store operations managers face significant challenges in effectively identifying weak points in their operations and taking appropriate steps to resolve them. The primary obstacle is the lack of time and/or expertise required to analyze data, learn from stores with good performance. identify causal relationships, and correctly set new targets for improvement. Current solutions often rely on manual inspection of dashboards and reports, which is labor-intensive, prone to errors, and limited by the availability of highly skilled personnel. This problem is particularly acute in the retail sector, where managers are accountable for performance across various sales, labor, and margin metrics. The complexity of these metrics, especially in sales, makes it nearly impossible to effectively track root causes of underperformance without sophisticated analytical tools. There is a clear need for an automated, data-driven solution that can quickly identify improvement opportunities, set achievable targets, and recommend specific actions across large retail organizations.

### BRIEF DESCRIPTION OF THE DRAWINGS

FIG. 1 is a diagram of a system for a multi-layer prescriptive recommendations machine learning model (MLM), according to an example embodiment.

FIG. 2 is a diagram depicting example layers of the multi-layer prescriptive recommendations MLM, according to an example embodiment.

FIG. 3 is a diagram of a system for retail sales key performance indicator (KPI) prescriptive analysis, according to an example embodiment.

FIG. 4 is a flow diagram of a method for providing and operating a multi-layer prescriptive recommendations MLM, according to an example embodiment.

FIG. 5 is a flow diagram of another method for providing and operating a multi-layer prescriptive recommendations MLM, according to an example embodiment.

FIG. 6 is a flow diagram of a method for providing and operating retail sales KPI prescriptive analysis, according to an example embodiment.

FIG. 7 is a flow diagram of another method for providing and operating retail sales KPI prescriptive analysis, according to an example embodiment.

### DETAILED DESCRIPTION

As stated above store operations managers face many challenges to effectively identify and resolve weak points in their store operations. Store managers often lack the necessary time and/or expertise to analyze data, learn from stores with good performance, identify causal relationships, and set appropriate improvement targets. Current solutions rely heavily on manual inspections of dashboards and reports, which are labor-intensive and prone to errors.

Further, the complexity of various operational metrics makes it nearly impossible to effectively track root causes of underperformance without sophisticated analytical tools. Consequently, stores that are trending flat or even improving on key metrics struggle to identify further opportunities for operational improvement.

Embodiments presented herein provide a generic multi-layer architecture of machine learning models (MLMs) that automate the process of identifying underperforming key performance indicators (KPIs), setting measurable targets and recommending specific prescriptive actions. A hierarchical structure of MLMs is employed without requiring extensive technical expertise from store managers. The hierarchical structure includes a first layer that predicts metric values for metrics of a given KPI, and a second layer that predicts feature values for features associated with given metric values. In an embodiment, the MLMs are regression MLMs.

Moreover, embodiments presented herein apply the generic MLM to specific sales KPIs commonly used in retail stores. A novel hierarchical logical layer of metrics related to sales KPIs is implemented. The MLMs are trained on historical sales data of a plurality of stores in a retail chain to identify improvement opportunities, set achievable targets, and generate actionable recommendations for each store. The implementation incorporates adjustments for different scales and distributions of features within a layered predictive MLM for hierarchical calculations and optimization techniques that consider the direction of improvement for each feature.

As a result, embodiments presented herein provide an automated data-driven approach that significantly improves store operations by allowing managers to make informed decisions without requiring extensive technical or business intelligence (BI) expertise. This approach addresses the current key challenges faced by retail operations management.

As used herein, a “KPI” is a high-level metric for which a store measures its success or failure in a certain area or areas of the store's operations. KPIs are defined based on common industry store operations and practices. For example, KPIs include year-over-year sales performance, weekly/monthly cashier labor hours, self-checkout interventions resulting in excessive transaction times, and others. KPIs are primary measurements of a store's performance. KPIs related to sales include, by way of example only, year-over-year daily sales comparisons, month-over-month sales comparisons, week-over-week daily sales comparisons, year-over-year weekly sales comparisons, year-over-year week-to-date sales comparisons, month-over-month week-to-date sales comparisons, month-over-month weekly sales comparisons, year-over-year month-to-date sales comparisons, year-over-year monthly sales comparisons, year-over-year month-to-date sales comparisons, quarter-over-quarter monthly sales comparisons, year-over-year quarter-to-date sales comparisons, year-over-year year-to-date sales comparisons, and others.

“Metrics” are secondary measurements tied to a given KPI. The metrics at least partially explain the performance of a KPI. Metrics are typically known to store operations personnel who commonly engage with BI/reporting tools. For example, if the year-over-year sales KPI is low for a store then it could be explained if secondary measurements (i.e., metrics) such as a total number of store visits, average basket amount, loyalty sales percentage, and performance of a certain department are running low. Metrics related to sales include, by way of example only, transaction count, average basket amount, average basket size, department sales, loyalty status amount, loyalty transaction count, online transaction rate, return rate, and others.

“Features” are the lowest level measurements. A feature or a set of features explains a metric or set of metrics. A feature drives a recommendation either directly or implicitly. Features are more specific by their nature, they enable given specific recommendations, and are therefore more actionable. For example, if a Deli performance metric is performing at X, then the following measurements are features that explain the metric: Deli sales performance during afternoon hours, Deli department penetration among loyalty customers, etc. Features related to sales include, by way of example only, average days between purchases for loyalty accounts, fractional discounts for online transactions, department return rate, transaction count for afternoon shift, basket penetration percentage for departments, basket penetration count for departments, average basket amount for loyalty versus non loyalty, factional discounts for loyalty transactions, discounted online items ratios, department return rate, transaction count for evening shift, basket penetration percentage for departments, department discounted item rates, average sales per loyalty transaction, department return rate vis-à-vis another department, transaction count for the night shift, basket penetration percentage for departments, department discount amount rates, fractional discounted loyalty transactions, percentage of understaffed hours, average days between loyalty purchases, average days between loyalty purchases, departments average days between loyalty purchases, department loyalty sales amount, discounted item ratios, average basket amount for loyalty versus no loyalty, department average basket amount for loyalty versus no loyalty, department loyalty sales amount relative to another department, average days between loyalty purchases, basket penetration count, department loyalty customer average monetary spend, department loyalty sales amount relative to another department, basket penetration count by department, department transaction count morning, department transaction count afternoon, department transaction count evening, department transaction count night shift, basket penetration count by department, department sales amount morning, department sales amount afternoon, department sales amount event, department sales amount night shift, and others.

Embodiments herein, produces a hierarchical explanation that starts with an observation that a given KPI can be improved, lays out metrics that are performing low and that impact the KPI, and for each metric lays out a list of features that will improve the corresponding metric. The identified features are presented as a measurable and achievable target within a user interface and/or provided to an existing business service or an existing business system for automated processing.

The MLMs presented herein are trained to find a connection between explanatory features and the label used to predict the outcome of unlabeled cases or to segment groups with similar feature values. The challenge is to find the connection of the explanatory features with a particular label (either metric of KPI), and then manipulate the feature values to see if and how those manipulated changes affect the label. Embodiments here solve this challenge in a computational efficient manner.

A multi-layer MLM is processed to recommend how to enhance a given KPI given the measures of many stores associated with a retailer (e.g., retailer's chain of stores). The first layer includes a single MLM for each available KPI, for which the explanatory features are the metrics (i.e., secondary measurements) and the label is the KPI. This level finds the connection between different business metrics and the KPI. The metrics are next explained in the second layer, which includes multiple MLMs. For each MLM in the second layer, the label is a corresponding business metric and the explanatory features (i.e., lowest level measurement) are the features that affect the corresponding business metric.

Embodiments herein provide a generic multi-layer MLM that can be applied to any primary business measurement for purposes of discovering how specific secondary and tertiary (i.e., lowest level) measurements can be changed to improve a value of the primary business measurement. Although embodiments herein discuss KPIs as primary measurements and more particularly sales KPIs, this is done for purposes of illustration only as other embodiments can include optimization of any primary business measurement.

In an embodiment, sales KPIs (i.e., primary sales KPIs) for a store of a retailer are applied to the generic multi-layer MLM and implemented to provide the store with an achievable and measurable target for the sales KPIs. The achievable or measurable target is a recommendation explaining how one or more features (lowest or tertiary level measurements) can be changed and by how much of a change to reach a desired sales KPI value for the store by affecting one or more metrics (secondary measurements), which thereby affects the sales KPIs.

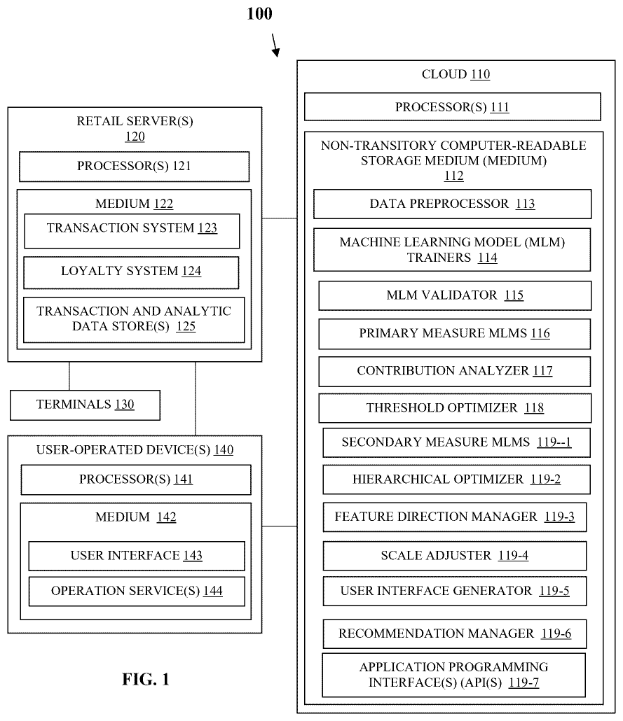

FIG. 1 is a diagram of a system for a multi-layer prescriptive recommendations MLM, according to an example embodiment. Notably, the components are shown schematically in simplified form, with only those components relevant to understanding of the embodiments being illustrated.

Furthermore, the various components (that are identified in system 100) are illustrated and the arrangement of the components are presented for purposes of illustration only. Notably, other arrangements with more or less components are possible without departing from the teachings of a multi-layer prescriptive recommendations MLM, presented herein and below.

System 100 includes a cloud 110, one or more retail servers 120, terminals 130, and one or more user-operated devices 140. Cloud 110 includes at least one processor 111 and a non-transitory computer-readable storage medium (hereinafter “medium”) 112, which includes instructions for data preprocessor 113, MLM trainer(s) 114, MLM validator 115, primary measure MLMs 116, contribution analyzer 117, threshold optimizer 118, secondary measure MLMs 119-1, hierarchical optimizer 119-2, feature direction manager 119-3, scale adjuster 119-4, user interface (UI) generator 119-5, recommendation manager 119-6, and/or application programming interface(s) (API(s)) 119-7. The instructions when executed by processor 111 cause processor 111 to perform processing or operations discussed herein and below with respect to 113-119-7.

Each retail server 120 includes at least one processor 121 and a medium 122, which includes instructions for a transaction system 123 and a loyalty system 124. The instructions when executed by processor 121 cause processor 121 to perform processing or operations discussed herein and below with respect to 123-124. Medium 122 also includes transaction and analytic data store(s) 125.

Each terminal 130 includes at least one processor and a medium having instructions for at least a transaction manager. The instructions when executed by the processor cause the processor to perform operations associated with the transaction manager. In an embodiment, the terminal is a self-service terminal (SST) or a point-of-sale (POS) terminal.

Each user-operated device 140 includes at least one processor 141 and a medium 142, which includes instructions for a user interface 143 and/or one or more operation services 144. The instructions when executed by processor 121 cause processor 121 to perform processing or operations discussed herein and below with respect to 134-144.

Notably and with the discussions that follow, the term and phrase “feature” and “feature value” depends on the context in which that term or phrase is being used. For example, when metric values for metrics are being optimized for predicting which metrics associated with a given KPI positively influence the KPI value, “feature” and “feature value” refers to the metrics and metric values (e.g., secondary measures). Similarly, when feature and feature values are used within the context of positively influence a given metric, the feature and feature values refer to tertiary measurements as discussed above.

Data preprocessor 113 is responsible for preparing the input data for the MLMs. The data preprocessor 113 obtains raw historical transactional data and analytical data from the transaction and analytic data store(s) 125 of a given retailer server 120. Data preprocessor identifies predefined features from the input data, performs data normalization on the extracted features, and provides missing values for features lacking values. Data preprocessor 113 ensures that the data from transaction and analytic data store(s) 125 is in a suitable format for training and analysis.

MLM trainer(s) 114 trains the primary measure MLMs 116 and the secondary measure MLMs 110-1. In an embodiment, the MLM trainer(s) 114 use regression MLMs to fit the MLMs to the preprocessed data, establishing connections between explanatory features and labels for both KPIs (primary measures) and metrics (secondary measures).

In an embodiment, the MLM trainer(s) 114 compare many regression MLMs and assign each hierarchy model with the MLM that is suitable to the features distributions. This approach ensures that every store can get a recommendation for improvement, even if a store is better than all other stores in one metric but not in another.

MLM validator 115 monitors training for the purpose of ensuring that the trained MLMs are performing well and are properly fitted to the data. This monitoring ensures proper maintenance of the accuracy and reliability of the system's recommendations.

Primary measure MLMs 116 are the first layer of MLMs that predict metric values (e.g., secondary measures) for a given KPI (primary measure). Each primary measure MLM 116 predicts a set of secondary measures (metric values), which correspond to the primary measure (e.g., KPI value). That is, each primary measure MLM 116 is specific to a given primary measure (e.g., KPI). The primary measure MLMs 116 establish the connection between different business metrics (e.g., secondary measures) and corresponding KPIs (e.g., primary measures).

Contribution analyzer 117 employs or processes feature contribution analysis algorithms, such as Shapley Values (SHAP) or local interpretable model-agnostic explanations (LIME), to detect the amount of contribution of every feature (e.g., secondary measure (metric) or tertiary measure (feature) to the change in label (e.g., KPI value prediction or metric value prediction). Contribution analyzer 117 provides a numerical value representing the relative contribution of each feature (e.g., metric when KPI prediction optimization is being processed with the primary measure MLMs 116 and feature when metric prediction optimization is being processed with the secondary measure MLMs 119-1). This analysis helps identify which features (e.g., metrics or tertiary measures) have the most significant impact on a corresponding KPI or a corresponding metric being optimized.

Threshold optimizer 118 determines and adjusts the thresholds used to identify significant features and to filter out insignificant features. The goal is ultimately to suggest a change in value for an explanatory feature and choose features that change the corresponding KPI significantly. Permutating all feature values is computationally expensive and changing feature values that had negligible contribution to the corresponding KPI will result in a negligible change in the corresponding KPI. Thus, threshold optimizer 118 uses thresholds corresponding to importance levels to filter out insignificant features. This component ensures that only features with meaningful contributions are considered for optimization, improving the efficiency of the system 100. In an embodiment, a statistical resampling algorithm is employed to identify the thresholds. In an embodiment, the thresholds are configurable; for example, if a retailer is interested in only 10% or more improvement, a given threshold can be configured to be 10% or higher.

For example, consider a sales KPI of a store in which contribution analyzer 117 determines that feature X (e.g., metric X or secondary measure) has an effect of increasing the sales KPI by plus 20%, feature Y has an effect of decreasing the sales KPI by minus 10%, and feature Z has an affect of increasing the sales KPI by plus 0.04%. Feature X contributed positively to the sales KIP value, feature Y contributed negatively to the sales KPI, and feature Z had a negligible contribution. In this instance, threshold optimizer 118 sets the feature value threshold at plus or minus 1% such that alternating feature values of X and Y are considered when attempting to increase the value of the sales KPI while feature Z is excluded from consideration entirely. Y is considered because it negatively impacts the sales KPI value and altering Y's value might result in a higher KPI value.

Secondary measure MLMs 119-1 form the second layer of MLMs that predict feature values for features (i.e., tertiary measures) associated with given metric values (e.g., secondary measures). The secondary MLMs 119-1 provide more granular insights into the factors affecting each metric or secondary measures underlying corresponding KPIs or primary measures. Each primary measure MLM 116 predicts the most impactful set of metrics that affect a given KPI whereas each secondary MLMs predicts the most impactful set of features (e.g., tertiary measures) that affect a given metric.

Hierarchical optimizer 119-2 manages the layered predictive MLMs that calculate recommendations hierarchically. Hierarchical optimizer 119-2 first optimizes the KPI and then uses the KPI optimization results for metric level optimization, ensuring consistency between the different layers of the multi-layered MLMs.

Feature direction manager 119-3 processes an optimization algorithm that considers the possible or potential optimization direction for each feature. This component ensures that features are optimized in the correct direction (increase or decrease) based on their impact on the metrics and KPIs.

Scale adjuster 119-4 manages the adjustments between different scales of each MLM and feature in the hierarchy. This component ensures the handling of the varying scales and distributions of features within the layered predictive MLMs.

Scale adjuster 119-4 also handles the differentiation between percentage-based features and absolute values features when calculating possible suggested changes. For example, when suggesting a change of KPI, such as year-over-year weekly sales, the metrics explain the year-over-year difference. However, when interpreting the metrics, system 100 recommends how to improve current performance. Therefore, the features are not compared to last year, but show the potential change in the last week that would have increased the metric. The computation is done between the different optimization steps in the hierarchy.

UI generator 119-5 is responsible for creating user-friendly interfaces to present the system's recommendations and insights. This component ensures that the complex analytical results are displayed in an easily understandable format for store managers and other users. In an embodiment, the UI generator 119-5 provides an artificial intelligence (AI) chat bot interface that uses natural language to communicate final recommendations generated by recommendation manager 119-6.

Recommendation manager 119-6 generates and manages the final recommendations based on the outputs from the various MLMs and optimizers. Recommendation manager 119-6 produces a hierarchical explanation that starts with an observation about a KPI that can be improved, outlines the underperforming metrics that impact the KPI, and provides a list of features that will improve each metric.

API(s) 119-7 provide interfaces for integrating the system's functionality with existing business services or systems, such as transaction system 123, loyalty system 124, and operation services 144. This allows for automated processing and seamless integration of the recommendations into the retailer's existing operational workflows.

Together, these components form a comprehensive system 100 that enables retailers to identify underperforming KPIs, set achievable targets, and generate specific, data-driven recommendations for improvement. The system 100 leverages advanced machine learning techniques and a hierarchical MLM structure to provide insights that would be difficult or impossible to obtain through manual analysis, thereby significantly enhancing retail operations management.

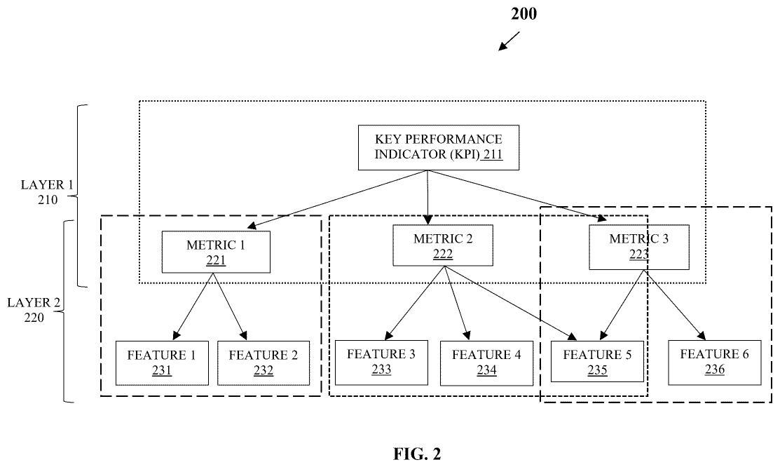

FIG. 2 is a diagram depicting example layers 200 of the multi-layer prescriptive recommendations MLM, according to an example embodiment. A two-layer hierarchy of MLMs is presented in FIG. 2. In the example illustration there are 4 separate MLMs. The first MLM is for predicting a given or a specific KPI value (e.g., primary measure) and utilizes three secondary measures as features that include metric 1 221, metric 2 222, and metric 3 223; this first layer MLM is enclosed by dotted lines in FIG. 2 and represents a first layer 210 for the two-layer hierarchy of MLMs.

The second layer 220 includes three MLMs, each MLM predicts a specific metric value for a specific one of metrics 221, metric 222, and metric 223. The first MLM predicts a metric value for metric 1 221 by utilizing feature values for feature 1 231 and feature 2 232. The second MLM predicts a metric value for metric 2 222 by utilizing feature values for feature 3 233, feature 4 234, and feature 5 235. The third MLM predicts a metric value for metric 3 223 by utilizing feature values for feature 5 235 and feature 6 236.

The first layer 210 is a specific primary measure MLM 116 that predicts a specific KPI value for the KPI illustrated in FIG. 2. Notably, each available and different KPI includes a different and specific primary measure MLM 116 such that the first layer 210 includes multiple MLMs, each MLM associated with a unique KPI being predicted. Similarly, the second layer 220 includes a plurality of secondary measure MLMs 119-1, each MLM predicts a specific metric value for a unique one of metrics 221, 222, or 223.

The KPI 211 is in layer 1 210 and is explained by metrics 221, 222, and 223. Metric 1 221 is in layer 2 220 and is explained by features 231 and 232, Metrics 233 and 234 are each explained by their own subset of features but both share the same feature 5 235.

System 100 optimizes the first MLM to reach a desired change in the KPI value, then the subset of metrics for optimization are chosen and altered. The altered values of the metrics are assigned to their corresponding MLMs, and system 100 processes to optimize the feature values for the corresponding features. Given the altered values of the features, system 100 provides predictions to the metrics and with the predicted metric values, system 100 provides a prediction to the KPI value of KPI 211.

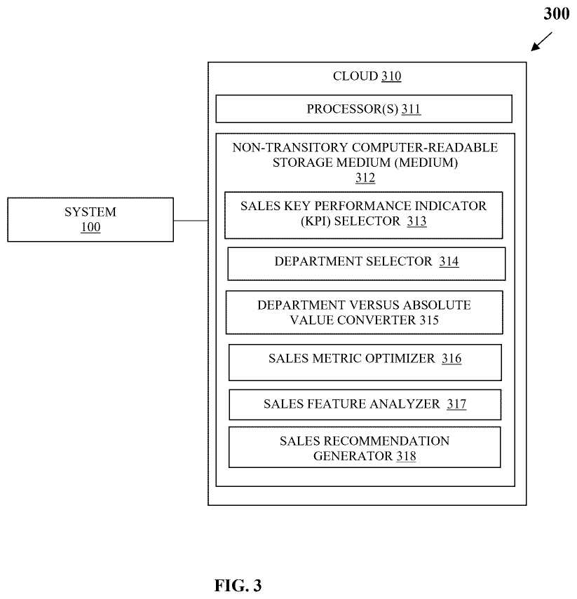

FIG. 3 is a diagram of a system 300 for retail sales key performance indicator (KPI) prescriptive analysis, according to an example embodiment. Notably, the components are shown schematically in simplified form, with only those components relevant to understanding of the embodiments being illustrated.

Furthermore, the various components (that are identified in system 300) are illustrated and the arrangement of the components are presented for purposes of illustration only. Notably, other arrangements with more or less components are possible without departing from the teachings of a multi-layer prescriptive recommendations MLM, presented herein and below.

System 300 includes at least one processor 311 and medium 312, which includes instructions for a sales KPI selector 313, a department selector 314, a department versus absolute value converter 315, a sales metric optimizer 316, a sales feature analyzer 317, and a sales recommendation generator 318. The instructions when executed by processor 311 cause the processor to perform operations with respect to 313-318.

Cloud 310 extends the functionality of system 100 to specifically address sales KPI optimization. It interacts closely with the components of system 100 to provide tailored recommendations for improving sales performance.

Sales KPI selector 313 is responsible for identifying and selecting the specific sales KPIs to be analyzed and optimized. This component works in conjunction with the primary measure MLMs 116 of system 100, focusing on sales-related KPIs such as year-over-year daily sales comparisons, month-over-month sales comparisons, and other relevant sales metrics.

Department selector 314 implements a strategy for choosing departments to optimize. It selects departments that are present in at least 75% of the stores and have a sales amount standard deviation among the high 50% of departments. This component interacts with the data preprocessor 113 and MLM trainer(s) 114 of system 100 to ensure that the selected departments provide meaningful insights across the store network.

Department selector 314 also incorporates some randomization in selecting the departments. This gives the user more versatile recommendations in every run of the system 100. The goal is to choose departments that could be found in many of the stores (to suggest improvements for most stores), but their metrics (e.g., sales amount) varied between the stores—allowing suggestions for improvement to one store based on another.

Percentage versus absolute value converter 315 handles the differentiation between percentage-based features and absolute value features when calculating possible suggested changes. This component works closely with the scale adjuster 119-4 of system 100 to ensure that the computations are consistent across different optimization steps in the hierarchy.

Sales metric optimizer 316 focuses on optimizing sales-specific metrics. It interacts with the secondary measure MLMs 119-1 and the hierarchical optimizer 119-2 of system 100 to fine-tune metrics such as total number of store visits, average basket amount, and loyalty sales percentage.

Sales feature analyzer 317 analyzes sales-specific features like deli sales performance during afternoon hours or deli department penetration among loyalty customers. This component works in tandem with the contribution analyzer 117 and feature direction manager 119-3 of system 100 to identify the most impactful features for improving sales metrics.

Sales recommendation generator 318 produces the final sales-specific recommendations based on the outputs from the various components. It integrates with the recommendation manager 119-6 and UI generator 119-5 of system 100 to present actionable insights tailored to improving sales performance.

Consider the following example for a processing scenario associated with system 300, a retail chain is experiencing a decline in year-over-year weekly sales comparisons across several stores. The sales KPI selector 313 identifies this as a key metric for optimization. The department selector 314 analyzes the data and determines that the Deli department is present in over 75% of stores and shows significant variability in performance.

The percentage versus absolute value converter 315 ensures that the year-over-year comparisons are properly calculated as percentages, while individual store metrics are considered in absolute values. The sales metric optimizer 316 identifies that the average basket size and loyalty program participation are key factors affecting the weekly sales comparisons.

The sales feature analyzer 317 drills down further and discovers that deli sales during afternoon hours and deli product penetration among loyalty customers are significant features impacting performance. Based on this analysis, the sales recommendation generator 318 produces a set of recommendations:
1. Increase deli sales during afternoon hours by 15%
2. Boost deli product penetration among loyalty customers by 10%
3. Implement a targeted loyalty program promotion for deli products

These recommendations are presented to store managers through the UI generator 119-5, providing them with specific, actionable insights to improve their year-over-year weekly sales comparisons. The system 300 continues to monitor performance and adjust recommendations as needed, leveraging the ongoing learning capabilities of the MLMs in system 100.

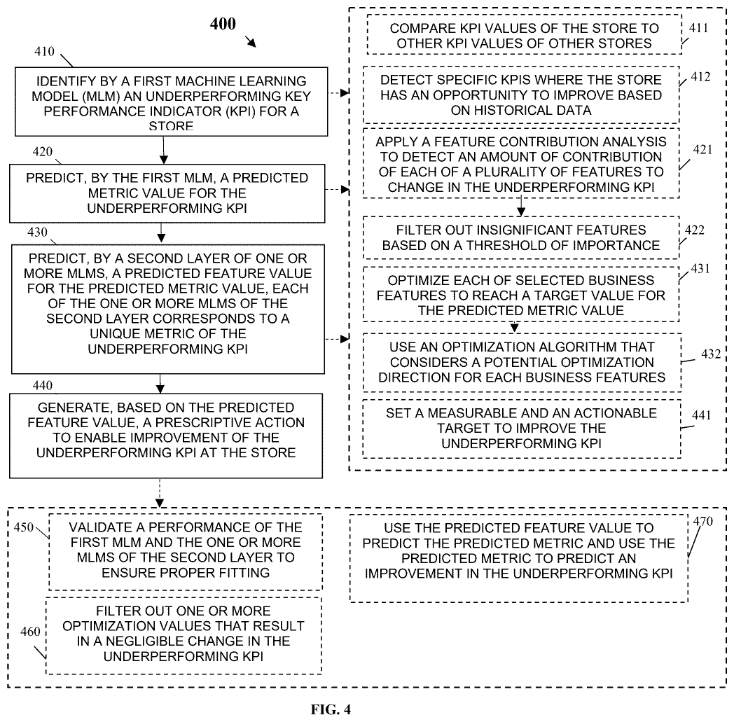

The above-referenced embodiments and other embodiments are now discussed with reference to FIGS. 4-7. FIG. 4 is a flow diagram of a method 400 for providing and operating a multi-layer prescriptive recommendations MLM, according to an example embodiment. The software module(s) that implements the method 400 is referred to as a “prescriptive recommender.” The prescriptive recommender is implemented as executable instructions programmed and residing within memory and/or a non-transitory computer-readable (processor-readable) storage medium and executed by one or more processors of one or more devices. The processor(s) of the device(s) that executes the prescriptive recommender are specifically configured and programmed to process the prescriptive recommender. The prescriptive recommender may have access to one or more network connections during its processing. The network connections can be wired, wireless, or a combination of wired and wireless.

In an embodiment, the devices that execute the prescriptive recommender is cloud 110 and/or retail server 120. In an embodiment, the prescriptive recommender is data preprocessor 113, MLM trainer(s) 114, MLM validator 115, primary measure MLMs 116, contribution analyzer 117, threshold optimizer 118, secondary measure MLMs 119-1, hierarchical optimizer 119-2, feature direction manager 119-3, scale adjuster 119-4, user interface (UI) generator 119-5, recommendation manager 119-6, and/or API(s) 119-7.

At 410, the prescriptive recommender identifies by using a first MLM an underperforming KPI for a store. In an embodiment, at 411, the prescriptive recommender compares KPI values for the store to other KPI values of other stores. In an embodiment, at 412, the prescriptive recommender detects specific KPIs where the store has an opportunity to improve based on historical data.

At 420, the prescriptive recommender predicts by using the first MLM a predicted metric value for the underperforming KPI. In an embodiment, at 421, the prescriptive recommender applies a feature contribution analysis to detect an amount of contribution of each of a plurality of features to change in the underperforming KPI. In an embodiment of 421 and at 422, the prescriptive recommender filters out or discards insignificant features based on a threshold of importance.

At 430, the prescriptive recommender predicts by using a second layer of one more MLMs a predicted feature value. Each of the one or more MLMs of the second layer corresponds to a unique metric of the underperforming KPI.

In an embodiment, at 431, the prescriptive recommender optimizes each of selected business features to reach a target value for the predicted metric value. In an embodiment of 431 and at 432, the prescriptive recommender uses an optimization algorithm that considers a potential optimization direction for each of the selected business features.

At 440, the prescriptive recommender generated, based on the predicted feature value, a prescriptive action to enable improvement of the underperforming KPI at the store. In an embodiment, at 441, the prescriptive recommender sets a measurable and actionable target to improve the underperforming KPI.

In an embodiment, at 450, the prescriptive recommender validates a performance of the first MLM and the one or more MLMs of the second layer to ensure proper fitting. In an embodiment, at 460, the prescriptive recommender filters out one or more optimization values that result in a negligible change in the underperforming KPI. In an embodiment, at 470, the prescriptive recommender uses the predicted feature value to predict the predicted metric value and uses the predicted metric value to predict and improvement in the underperforming KPI.

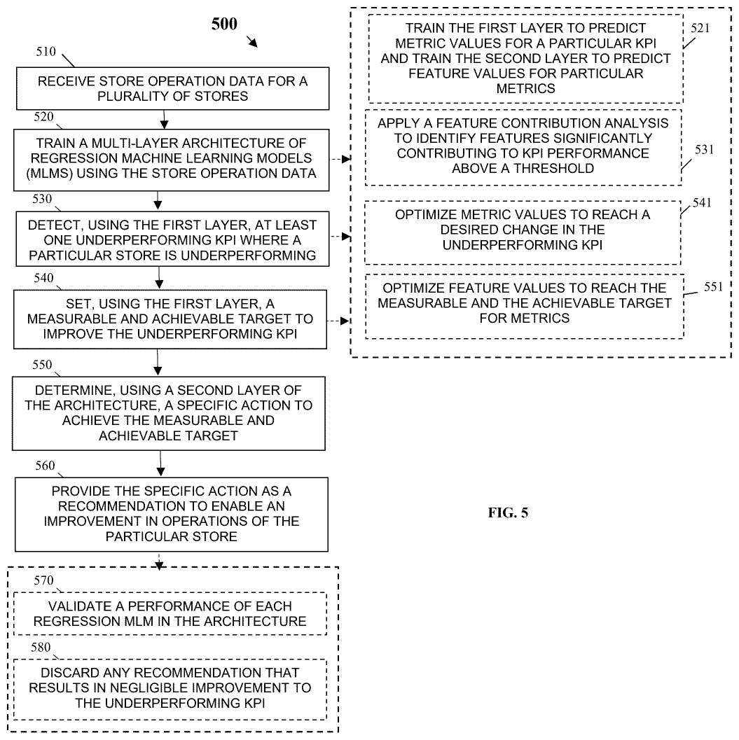

FIG. 5 is a flow diagram of another method 500 for providing and operating a multi-layer prescriptive recommendations MLM, according to an example embodiment, according to an example embodiment. The software module(s) that implements the method 600 is referred to as a “primary measure prescriptive recommender.” The primary measure prescriptive recommender is implemented as executable instructions programmed and residing within memory and/or a non-transitory computer-readable (processor-readable) storage medium and executed by one or more processors of one or more device(s). The processors that execute the primary measure prescriptive recommender are specifically configured and programmed for processing the primary measure prescriptive recommender. The primary measure prescriptive recommender may have access to one or more network connections during its processing. The network connections can be wired, wireless, or a combination of wired and wireless.

In an embodiment, the device that executes the primary measure prescriptive recommender is cloud 110 and/or retail server 120. In an embodiment, the primary measure prescriptive recommender is the prescriptive recommender is data preprocessor 113, MLM trainer(s) 114, MLM validator 115, primary measure MLMs 116, contribution analyzer 117, threshold optimizer 118, secondary measure MLMs 119-1, hierarchical optimizer 119-2, feature direction manager 119-3, scale adjuster 119-4, user interface (UI) generator 119-5, recommendation manager 119-6, API(s) 119-7, and/or method 400. In an embodiment, the primary measure prescriptive recommender presents another and, in some ways, and enhanced processing perspective from that which was described above for method 400 of FIG. 4.

At 510, the primary measure prescriptive recommender receives store operation data for a plurality of stores. The primary measure prescriptive recommender obtains the store operation data from corresponding transaction and analytic data stores 125.

At 520, the primary measure prescriptive recommender trains a multi-layer architecture of regression MLMs using the store operation data. In an embodiment, at 521, the primary measure prescriptive recommender trains the first layer to predict metric values for a particular KPI and trains the second layer to predict feature values for particular metrics.

At 530, the primary measure prescriptive recommender detects, using the first layer, at least one underperforming KPI where a particular store is underperforming. In an embodiment, at 531, the primary measure prescriptive recommender applies a feature contribution analysis to identify features significantly contributing to KPI performance above a threshold.

At 540, the primary measure prescriptive recommender sets, using the first layer, a measurable and achievable target to improve the underperforming KPI. In an embodiment, at 541, the primary measure prescriptive recommender optimizes the metric values to reach a desired change in the underperforming KPI.

At 550, the primary measure prescriptive recommender determines, using a second layer of the multi-layer architecture, a specific action to achieve the measurable and achievable target. In an embodiment, at 551, the primary measure prescriptive recommender optimizes feature values to reach the measurable and the achievable target for metrics.

At 560, the primary measure prescriptive recommender provides the specific action as a recommendation to enable an improvement in operations of the particular store. In an embodiment, at 570, the primary measure prescriptive recommender validates a performance of each regression MLM in the multi-layer architecture. In an embodiment, at 580, the primary measure prescriptive recommender discards any recommendation that results in negligible improvement to the underperforming KPI.

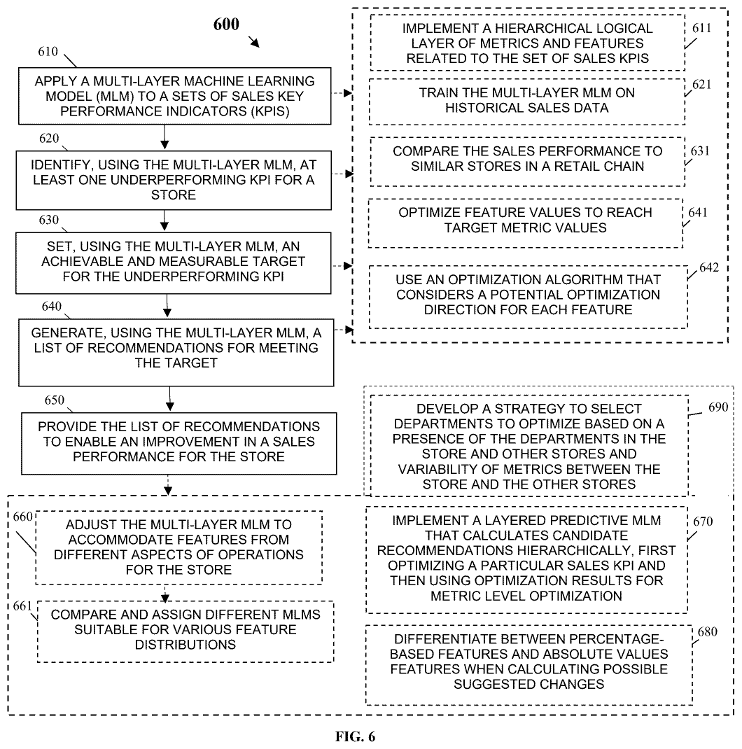

FIG. 6 is a flow diagram of a method 600 for providing and operating retail sales KPI prescriptive analysis, according to an example embodiment. The software module(s) that implements the method 600 is referred to as a “sales prescriptive recommender.” The sales prescriptive recommender is implemented as executable instructions programmed and residing within memory and/or a non-transitory computer-readable (processor-readable) storage medium and executed by one or more processors of one or more device(s). The processors that execute the sales prescriptive recommender are specifically configured and programmed for processing the sales prescriptive recommender. The sales prescriptive recommender may have access to one or more network connections during its processing. The network connections can be wired, wireless, or a combination of wired and wireless.

In an embodiment, the device that executes the sales prescriptive recommender is cloud 310, cloud 110, and/or retail server 120. In an embodiment, the sales prescriptive recommender is sales KPI selector 313, department selector 314, department versus absolute value converter 315, sales metric optimizer 316, sales feature analyzer 317, and/or sales recommendation generator 318. Furthermore, the sales prescriptive recommender interacts with and is a specific sales KPI implementation of system 100 such that the components of system 100 are customized, configured, interacted with, and/or used by the sales prescriptive recommender.

At 610, the sales prescriptive recommender applies a multi-layer MLM to sets of sales KPIs. In an embodiment, at 611, the sales prescriptive recommender implements a hierarchical logical layer of metrics and features related to the set of sales KPIs.

At 620, the sales prescriptive recommender identifies using the multi-layer MLM, at least one underperforming KPI for a store. In an embodiment, at 621, the sales prescriptive recommender trains the multi-layer MLM on historical sales data.

At 630, the sales prescriptive recommender sets, using the multi-layer MLM, an achievable and measurable target for the underperforming KPI. In an embodiment, at 631, the sales prescriptive recommender compares the sales performance to similar stores in a retail chain of a retailer.

At 640, the sales prescriptive recommender generates, using the multi-layer MLM, a list of recommendations for meeting the achievable and measurable target. In an embodiment, at 641, the sales prescriptive recommender optimizes feature values to reach target metric values. In an embodiment, at 642, the sales prescriptive recommender uses an optimization algorithm that considers a potential optimization direction for each feature.

At 650, the sales prescriptive recommender provides the list of recommendations to enable an improvement in sales performance for the store. In an embodiment, at 660, the sales prescriptive recommender adjusts the multi-layer MLM to accommodate features from different aspects of operations for the store. In an embodiment of 660 and at 661, the sales prescriptive recommender compares and assigns different MLMs suitable for various feature distributions.

In an embodiment, at 670, the sales prescriptive recommender implements a layered predictive MLM that calculates candidate recommendations hierarchically, first optimizing a particular sales KPI and then using optimization results for metric level optimization. In an embodiment, at 680, the sales prescriptive recommender differentiates between percentage-based features and absolute values features when calculating possible suggested changes. In an embodiment, at 690, the sales prescriptive recommender develops a strategy to select departments to optimize based on a presence of the departments in the store and other stores and variability of metrics between the store and the other stores.

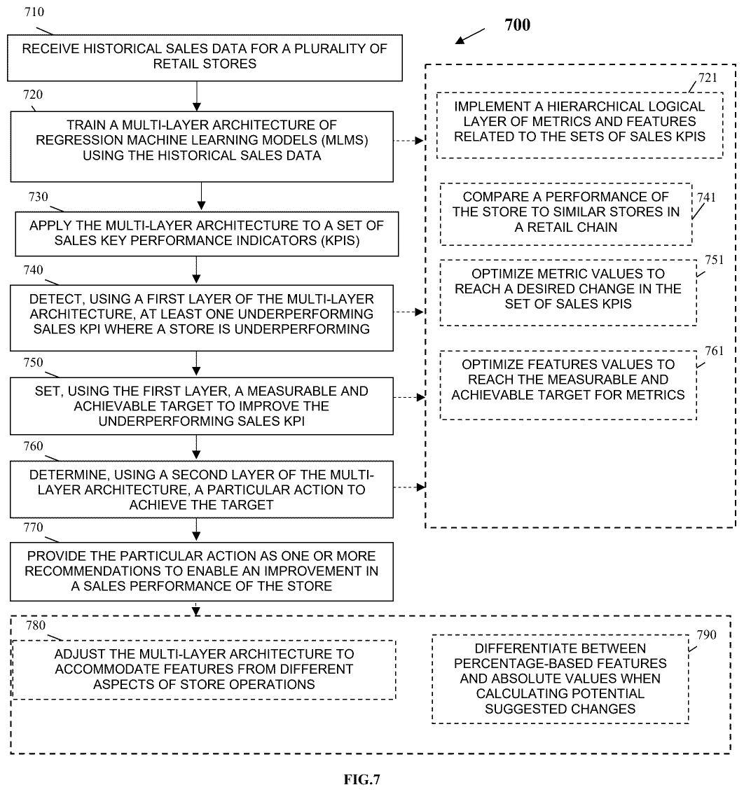

FIG. 7 is a flow diagram of another method 700 for providing and operating retail sales KPI prescriptive analysis, according to an example embodiment. The software module(s) that implements the method 800 is referred to as a “sales prescriptive recommendation manager.” The sales prescriptive recommendation manager is implemented as executable instructions programmed and residing within memory and/or a non-transitory computer-readable (processor-readable) storage medium and executed by one or more processors of one or more device(s). The processors that execute the sales prescriptive recommendation manager are specifically configured and programmed for processing the sales prescriptive recommendation manager. In an embodiment, the sales prescriptive recommendation manager may have access to one or more network connections during its processing. The network connections can be wired, wireless, or a combination of wired and wireless.

In an embodiment, the device that executes the sales prescriptive recommendation manager is cloud 310, cloud 110, and/or retail server 120. In an embodiment, the sales prescriptive recommendation manager is sales KPI selector 313, department selector 314, department versus absolute value converter 315, sales metric optimizer 316, sales feature analyzer 317, sales recommendation generator 318, and/or method 600. Furthermore, the sales prescriptive recommendation manager interacts with and is a specific sales KPI implementation of system 100 such that the components of system 100 are customized, configured, interacted with, and/or used by the sales prescriptive recommendation manager. The sales prescriptive recommendation manage presents another and, in some ways, an enhanced processing perspective from that which was described above for method 600 of FIG. 6.

At 710, the sales prescriptive recommendation manager receives historical sales data for a plurality of retail stores. The sales prescriptive recommendation manager obtains the historical sales data from corresponding transaction and analytic data stores 125.

At 720, the sales prescriptive recommendation manager trains a multi-layer architecture of regressing MLMs using the historical sales data. In an embodiment, at 721, the sales prescriptive recommendation manager implements a hierarchical logical layer of metrics and features related to the sets of sales KPIs.

At 730, the sales prescriptive recommendation manager applies the multi-layer architecture to a set of sales KPIs. At 740, the sales prescriptive recommendation manager detects, using a first layer of the multi-layer architecture, at least one underperforming sales KPI where a store is underperforming. In an embodiment, at 741, the sales prescriptive recommendation manager compares a performance of the store to similar stores in a retail chain of a retailer.

At 750, the sales prescriptive recommendation manager sets, using a second layer of the multi-layer architecture, a measurable and achievable target to improve the underperforming sales KPI. In an embodiment, at 751, the sales prescriptive recommendation manager optimizes metric values to reach a desired change in the set of sales KPIs.

At 760, the sales prescriptive recommendation manager determines, using a second layer of the multi-layer architecture, a particular action to achieve the measurable and achievable target. In an embodiment, at 761, the sales prescriptive recommendation manager optimizes feature values to reach the measurable and achievable target for metrics.

At 770, the sales prescriptive recommendation manager provides the particular action as one or more recommendations to enable an improvement in a sales performance of the store. In an embodiment, at 780, the sales prescriptive recommendation manager adjusts the multi-layer architecture to accommodate features from different aspects of store operations. In an embodiment, at 790, the sales prescriptive recommendation manager differentiates between percentage-based features and absolute values features when calculating potential suggested changes.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method comprising:
applying a multi-layer machine learning model (MLM) to a set of sales key performance indicators (KPIs);
identifying, using the multi-layer MLM, at least one underperforming sales KPI for a store;
setting, using the multi-layer MLM, an achievable and measurable improvement target for the at least one underperforming sales KPI;
generating, using the multi-layer MLM, a list of recommendations for meeting the achievable and measurable improvement target; and
providing the list of recommendations to enable an improvement in a sales performance for the store.

2. The method of claim 1, wherein applying further includes implementing a hierarchical logical layer of metrics and features related to the set of sales KPIs.

3. The method of claim 1, wherein identifying further includes training the multi-layer MLM on historical sales data.

4. The method of claim 1, wherein setting further includes comparing the sales performance to similar stores in a retail chain.

5. The method of claim 1, wherein generating further includes optimizing feature values to reach target metric values.

6. The method of claim 5, wherein optimizing further includes using an optimization algorithm that considers a potential optimization direction for each feature.

7. The method of claim 1, further comprising adjusting the multi-layer MLM to accommodate features from different aspects of store operations.

8. The method of claim 7, wherein adjusting further includes comparing and assigning different MLMs suitable for various feature distributions.

9. The method of claim 1, further comprising implementing a layered predictive MLM that calculates candidate recommendations hierarchically, first optimizing a particular sales KPI and then using optimization results for metric level optimization.

10. The method of claim 1, further comprising differentiating between percentage-based features and absolute values features when calculating possible suggested changes.

11. The method of claim 1, further comprising developing a strategy to select departments to optimize based on a presence of the departments in the store and other stores and variability of metrics between the store and the other stores.

12. A method comprising:
receiving historical sales data for a plurality of retail stores;
training a multi-layer architecture of regression machine learning models (MLMs) using the historical sales data;
applying the multi-layer architecture to a set of sales key performance indicators (KPIs);
detecting, using a first layer of the multi-layer architecture, at least one underperforming sales KPI where a store is underperforming;
setting, using the first layer, a measurable and achievable target to improve the at least one underperforming sales KPI;
determining, using a second layer of the multi-layer architecture, a particular action to achieve the measurable and achievable target; and
providing the particular action as one or more recommendations for improving a sales performance of the store.

13. The method of claim 12, wherein training further includes implementing a hierarchical logical layer of metrics and features related to the set of sales KPIs.

14. The method of claim 12, wherein detecting further includes comparing a performance of the store to similar stores in a retail chain.

15. The method of claim 12, wherein setting further includes optimizing metric values to reach a desired change in the set of sales KPI.

16. The method of claim 12, wherein determining further includes optimizing feature values to reach the measurable and achievable target for metrics.

17. The method of claim 12, further comprising adjusting the multi-layer architecture to accommodate features from different aspects of store operations.

18. The method of claim 12, further comprising differentiating between percentage-based features and absolute values features when calculating potential suggested changes.

19. A system comprising:
a processor;
a memory storing instructions that, when executed by the processor, cause the system to:
implement a multi-layer architecture of machine learning models (MLM) for a set of sales key performance indicators (KPIs);
identify, using the multi-layer architecture, at least one underperforming sales KPI for a store;
set, using the multi-layer architecture, an achievable and measurable improvement target for the at least one underperforming sales KPI;
generate, using the multi-layer architecture, a list of recommendations for meeting the achievable and measurable improvement target; and
provide the list of recommendations to enable an improvement in a sales performance for the store.

20. The system of claim 19, wherein the instructions further cause the processor to adjust the multi-layer architecture to accommodate features from different aspects of store operations and differentiate between percentage-based features and absolute values features when calculating potential suggested changes.
